(19) United States
(12) Patent Application Publication
(10) Pub. No.: US 2013/0059221 A1
(43) Pub. Date: Mar. 7, 2013

(54) FUEL CELL SYSTEM AND HEATING METHOD BY USING HEAT FROM FUEL CELL

(71) Applicant: Koji Katano, Toyota-shi (JP)

(72) Inventor: Koji Katano, Toyota-shi (JP)

(73) Assignee: TOYOTA JIDOSHA KABUSHIKI KAISHA, Toyota-shi (JP)

(21) Appl. No.: 13/698,046

(22) PCT Filed: May 19, 2010
(86) PCT No.: PCT/JP2010/003368

§ 371 Date: Nov. 14, 2012

(51) Int. Cl. H01M 8/04

(52) U.S. Cl. 429/432; 429/440

(57) ABSTRACT

A fuel cell system includes: a fuel cell configured to have a cell stack obtained by stacking a plurality of cells; a heat exchanger located in a middle position in a stacking direction of the cell stack and configured to have a flow channel that allows passage of a fluid for heat exchange; and a heating system configured to use the fluid that passes through the flow channel for heating.

### TECHNICAL FIELD

The present invention relates to a fuel cell system and a heating method by using heat of a fuel cell.

### BACKGROUND ART

The technique disclosed in, for example, Patent Literature 1 has been known to use the waste heat of a fuel cell.

This technique, however, has not fully innovated the system of using the heat generated in the fuel cell. This problem is not characteristic of the fuel cell system mounted on the vehicle but is commonly found in any fuel cell system that uses the heat generated in the fuel cell.

### CITATION LIST

### Patent Literatures

PTL1: JP 2009-245627A

PTL2: JP 2003-130491A

PTL3: JP 2001-167779A

### SUMMARY

### Technical Problem

In order to solve at least part of the foregoing, the subject of the invention is to provide a technique of efficiently using heat generated in a fuel cell.

### Solution to Problem

In order to achieve at least part of the foregoing, the invention provides aspects and embodiments described below.

(1) According to a first aspect, there is provided a fuel cell system that includes: a fuel cell configured to have a cell stack obtained by stacking a plurality of cells; a heat exchanger located in a middle position in a stacking direction of the cell stack and configured to have a flow channel that allows passage of a fluid for heat exchange; and a heating system configured to use the fluid that passes through the flow channel for heating.

In this configuration, the heat exchanger enables efficient heat exchange with the cell stack of the fuel cell, and the heating system enables efficient use of the heat generated in the fuel cell.

(2) According to a second aspect, there is provided the fuel cell system of the first aspect, which further includes a temperature sensor provided to detect temperature of the fluid.

The temperature of the fluid is correlated to the temperature of the fuel cell, so that this configuration can estimate the temperature of the fuel cell from the detected temperature of the fluid.

(3) According to a third aspect, there is provided the fuel cell system of the second aspect, which further includes: a circulation circuit arranged to circulate a coolant for cooling down the fuel cell; and a circulation controller configured to control flow of the coolant that is circulated through the circulation circuit, based on the detected temperature of the fluid.

This configuration can control the circulation of the coolant, based on the temperature of the fluid correlated to the temperature of the fuel cell.

(4) According to a fourth aspect, there is provided the fuel cell system of the third aspect, wherein the circulation controller starts circulation of the coolant, when it is determined that the detected temperature of the fluid exceeds a predetermined level.

This configuration can detect a temperature increase of the fuel cell during warm-up operation of the fuel cell without starting circulation of the coolant. This advantageously shortens the time required for the warm-up operation of the fuel cell and prevents overheat of the fuel cell.

(5) According to a fifth aspect, there is provided the fuel cell system of any one of the first to the fourth aspects, which further includes: a casing provided to cover over the fuel cell, wherein the fluid is a gas, and a flow inlet that allows the fluid to flow into the flow channel of the heat exchanger is provided in an inner space of the casing.

This configuration advantageously prevents any foreign substance from entering the flow channel of the heat exchanger.

(6) According to a sixth aspect, there is provided the fuel cell system of the fifth aspect, which further includes a hydrogen concentration detector configured to detect hydrogen concentration of the fluid.

This configuration can detect a leakage of hydrogen from the fuel cell.

(7) According to a seventh aspect, there is provided the fuel cell system of the sixth aspect, which further includes: a fluid supplier configured to supply the fluid that passes through the flow channel of the heat exchanger to the heating system; and a hydrogen concentration determiner configured to determine whether the detected hydrogen concentration exceeds a predetermined value, wherein the fluid supplier stops the supply of the fluid to the heating system when the detected hydrogen concentration exceeds the predetermined value.

This configuration advantageously interferes with supply of hydrogen to the heating system when a leakage of hydrogen from the fuel cell is detected.

(8) According to an eighth aspect, there is provided the fuel cell system of either one of the sixth and seventh aspects, wherein the flow inlet is provided in an upper portion of the inner space of the casing.

Hydrogen leaked from the fuel cell is likely to be accumulated in the upper portion of the casing. This configuration enables a leakage of hydrogen from the fuel cell to be detected with a high sensitivity.

(9) According to a ninth aspect, there is provided the fuel cell system of any one of the second to the eighth aspects, which further includes: a second temperature sensor configured to detect temperature of a coolant for cooling down the fuel cell; and a flow rate controller configured to control a flow rate of the fluid, based on the detected temperature of the coolant and the detected temperature of the fluid.

This configuration controls the flow rate of the fluid, thereby regulating the temperature of the fuel cell.

(10) According to a tenth aspect, there is provided the fuel cell system of the ninth aspect, wherein the flow rate controller increases the flow rate of the fluid, when it is determined that the detected temperature of the coolant exceeds a specified level and when it is determined that the detected temperature of the fluid exceeds a predetermined level.

This configuration advantageously prevents overheat of the fuel cell and thereby protects electrolyte membranes included in the fuel cell from being dried.

(11) According to an eleventh aspect, there is provided the fuel cell system of either one of the ninth and tenth aspects, which further includes: a fluid supplier configured to supply the fluid that passes through the flow channel of the heat exchanger to the heating system; and a valve provided in the fluid supplier and configured to release the fluid that passes through the flow channel of the heat exchanger, to outside, wherein the fluid is a gas, and the valve is opened when the heating system does not use the fluid for heating.

This configuration can release the fluid that passes through the flow channel of the heat exchanger to the outside when the heating system does not use the fluid for heating.

(12) According to a twelfth aspect, there is provided the fuel cell system of any one of the first to the eleventh aspects, wherein the heat exchanger is provided with a through hole formed to allow passage of a coolant for cooling down the fuel cell.

In this configuration, the heat exchanger enables heat exchange with the coolant.

(13) According to a thirteenth aspect, there is provided the fuel cell system of any one of the first to the twelfth aspects, wherein the heat exchanger is provided at an approximate center in the stacking direction of the cell stack.

The approximate center of the cell stack has the relatively higher temperature than the temperature of the other part of the cell stack. In this configuration, the heat exchanger enables efficient heat exchange with the cell stack of the fuel cell.

(14) According to a fourteenth aspect, there is provided the fuel cell system of any one of the first to the thirteenth aspects, which further includes: an oxidizing gas supply volume setter configured to set a supply volume of an oxidizing gas supplied to the fuel cell, based on an output required for the fuel cell and an amount of heat required by the heating system; and an oxidizing gas supplier configured to supply the oxidizing gas to the fuel cell, based on the set supply volume of the oxidizing gas.

This configuration enables an adequate amount of the oxidizing gas to be supplied to the fuel cell, in order to satisfy both the output required for the fuel cell and the amount of heat required by the heating system.

(15) According to a fifteenth aspect, there is provided the fuel cell system of any one of the first to the fourteenth aspects, wherein the fuel cell is in a potentially floating state, and the heat exchanger is grounded via a resistor. The fuel cell system further includes a voltage detector configured to detect a potential difference between both ends of the resistor.

Dielectric breakdown occurring in the fuel cell causes a potential difference between both ends of the resistor. This configuration can thus detect dielectric breakdown of the fuel cell.

The present invention may be implemented by various aspects, for example, a method and an apparatus for heating by using heat of a fuel cell, an integrated circuit and a computer program provided to enable the functions of such a method or apparatus, and a storage medium that stores such a computer program therein.

### BRIEF DESCRIPTION OF DRAWINGS

FIG. 1 illustrates the general configuration of a fuel cell system 10 according to one embodiment of the invention;

FIG. 2 illustrates the circulation start timing of cooling water at the start-up of a fuel cell 100;

FIG. 3 illustrates the relationship between the output characteristics of the fuel cell 100 and the air stoichiometric ratio;

FIG. 4 illustrates the main part of the configuration of a fuel cell system 10b according to a second embodiment;

FIG. 5 illustrates the configuration of a heat exchanger 170b according to the second embodiment;

FIG. 6 illustrates an enlarged cross section of the heat exchanger 170b and its periphery;

FIG. 7 is a flowchart showing a processing flow performed by an air conditioning device 150b;

FIG. 8 illustrates the main part of the configuration of a fuel cell system 10c according to a third embodiment; and

FIG. 9 illustrates the main part of the configuration of a fuel cell system 10d according to a fourth embodiment.

### DESCRIPTION OF EMBODIMENTS

The aspects of the invention are described below with reference to embodiments.

### A. First Embodiment

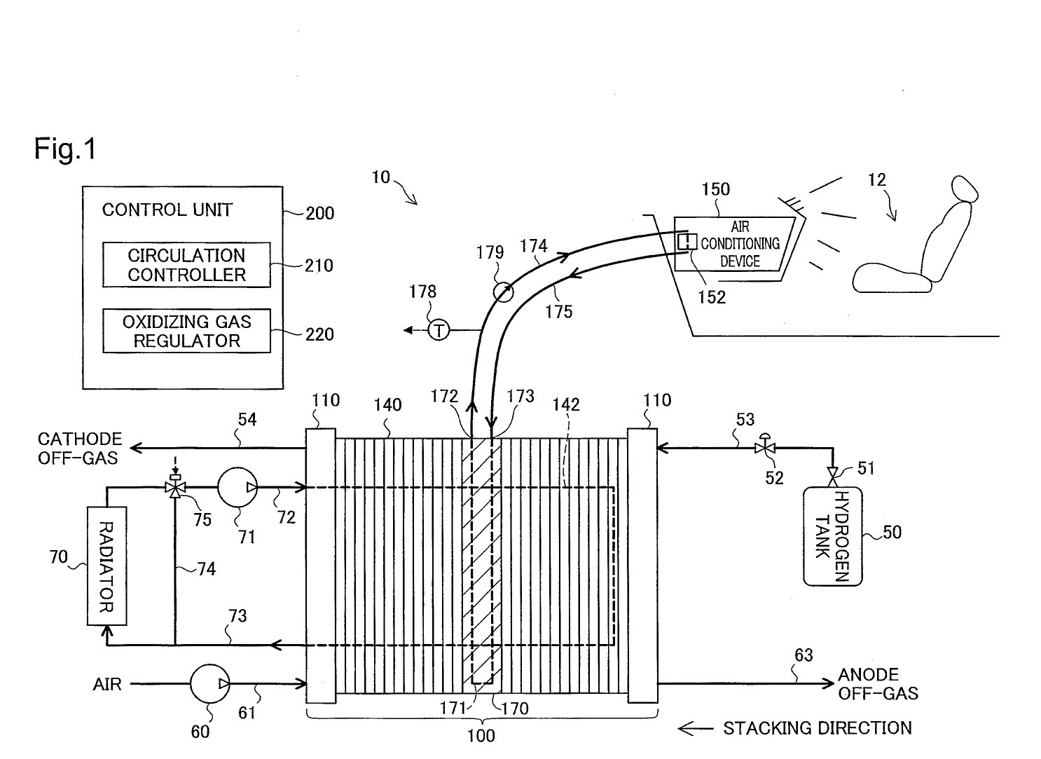

FIG. 1 illustrates the general configuration of a fuel cell system 10 according to one embodiment of the invention. The fuel cell system 10 of the embodiment is mounted on a vehicle and mainly includes a fuel cell 100, an air conditioning device 150 that heats or cools a vehicle interior 12 and a control unit 200 that controls the whole fuel cell system 10.

The fuel cell 100 includes a cell stack 140 provided by stacking a plurality of cells, a heat exchanger 170 located in the middle position in the stacking direction of the cell stack 140, and end plates 110 provided to hold the cell stack 140 therebetween.

The control unit 200 includes a circulation controller 210 that controls circulation of a coolant used to cool the fuel cell 100 and an oxidizing gas regulator 220 that regulates the amount of an oxidizing gas (air) supplied to the fuel cell 100. The details of these elements will be described later.

The fuel cell 100 receives hydrogen gas as the fuel gas supplied from a hydrogen tank 50 that stores high-pressure hydrogen via a shut valve 51, a regulator 52 and a piping 53. The remaining fuel gas (anode off-gas) unconsumed in the fuel cell 100 flows through an exhaust piping 63 and is discharged out of the fuel cell 100. The fuel cell system 10 may have a recirculation mechanism that recirculates the anode off-gas to the piping 53.

The fuel cell 100 also receives the air as the oxidizing gas supplied via an air pump 60 and a piping 61. The remaining oxidizing gas (cathode off-gas) unconsumed in the fuel cell 100 flows through an exhaust piping 54 and is discharged out of the fuel cell 100. The fuel gas and the oxidizing gas are also called reactive gases.

The fuel cell 100 further receives the coolant cooled down by a radiator 70 and supplied via a water pump 71 and a piping 72 in order to cool the fuel cell 100. The coolant supplied to the fuel cell 100 is circulated through a manifold 142 formed inside the fuel cell 100 and is discharged out of the fuel cell 100. The coolant also flows through in the respective cells of the cell stack 140, although not being specifically illustrated. The coolant discharged out of the fuel cell 100 flows through a piping 73 and is circulated to the radiator 70. The coolant may be, for example, water, an antifreeze such as ethylene glycol, or the air.

A piping 74 that bypasses the radiator 70 is connected with the piping 73 and the piping 72. The circulation controller 210 switches over a three-way valve 75 provided in the piping 72 to change the flow channel of the coolant. When cooling down the fuel cell 100 is not required, for example, in the cold environment, the circulation controller 210 switches over the three-way valve 75 to introduce the coolant into the piping 74, i.e., to prevent the coolant from flowing into the radiator 70.

The heat exchanger 170 is located in the middle position in the stacking direction of the cell stack 140 and thereby allows efficient heat exchange with the cell stack 140. In the description hereof, the “middle position” is not limited to the center position of the cell stack 140 but means any position between adjacent cells of the cell stack 140. The heat exchanger 170 has an internal flow channel 171 provided to allow passage of a fluid (heat medium) for heat exchange. Power generation by the fuel cell 100 is accompanied with heat generation and thus increases the temperature of the heat medium in the heat exchanger 170 and in the flow channel 171. According to this embodiment, an antifreeze is used for the heat medium.

With a view to clearly discriminating this heat medium from the coolant used to cool the fuel cell 100 described above, hereinafter the fluid flowing through the internal flow channel 171 of the heat exchanger 170 is called “heat medium”, while the coolant used to cool the fuel cell 100 is called “cooling water”.

It is preferable that the heat exchanger 170 is placed at the approximate center in the stacking direction of the cell stack 140 as described in this embodiment. This is because of the following reason. On start of power generation by the fuel cell 100, the center area of the cell stack 140 is insusceptible to the influence of heat release by the end plates 110 and is thus warmed earlier than the peripheral area to the relatively higher temperature than that of the peripheral area. According to the embodiment, locating the heat exchanger 170 at the approximate center in the stacking direction of the cell stack 140 ensures efficient heat exchange. Alternatively the heat exchanger 170 may be placed off-center to either one of the end plates 110 in the middle position of the cell stack 140.

A flow channel 174 is connected with a flow outlet 172 of the flow channel 171, and a flow channel 175 is connected with a flow inlet 173 of the flow channel 171. The flow channel 174 and the flow channel 175 are connected with a heat exchanger 152 included in the air conditioning device 150.

The flow channel 174 is provided with a temperature sensor 178 configured to measure the temperature of the heat medium flowing out of the heat exchanger 170 and with a circulation pump 179 configured to supply the heat medium flowing out of the heat exchanger 170 to the heat exchanger 152 of the air conditioning device 150. The temperature of the heat medium flowing through the flow channel 174 is correlated to the temperature of the fuel cell 100. The temperature of the fuel cell 100 can thus be estimated by measuring the temperature of the heat medium flowing through the flow channel 714 by the temperature sensor 178. Additionally, when the heat exchanger 170 is placed at the approximate center in the stacking direction of the cell stack 140 as described above, the temperature at the highest-temperature-position of the fuel cell 100 can be detected by the temperature sensor 178.

The air conditioning device 150 uses the heat of the heat exchanger 152 to heat the vehicle interior 12 (for example, air blow from a defroster). In other words, the air conditioning device 150 uses the heat medium flowing through the flow channel 171 of the heat exchanger 170 to heat the vehicle interior 12. As described above, the heat exchanger 170 allows efficient heat exchange with the fuel cell 100, so that the air conditioning device 150 can efficiently use the heat of the fuel cell 100 for heating.

Cooling water hoses made of, for example, a flexible material such as elastic rubber may be employed for the flow channel 174 and the flow channel 175 connecting the heat exchanger 170 with the air conditioning device 150. This configuration advantageously increases the flexibility in the layout of the fuel cell 100 and the air conditioning device 150 mounted on the vehicle. Especially this is effective in the layout of the fuel cell 100 mounted in a front portion of the vehicle (i.e., in an engine compartment) in its moving direction.

The circulation controller 210 controls the flow of cooling water to cool down the fuel cell 100, based on the temperature of the heat medium measured by the temperature sensor 178. More specifically, the circulation controller 210 controls the start of circulation of cooling water at the start-up of the fuel cell 100. The flow of cooling water for cooling down the fuel cell 100 may be controlled based on the temperature of the heat medium measured by the temperature sensor 178, because the temperature of the fuel cell 100 is correlated to the temperature of the heat medium as mentioned above.

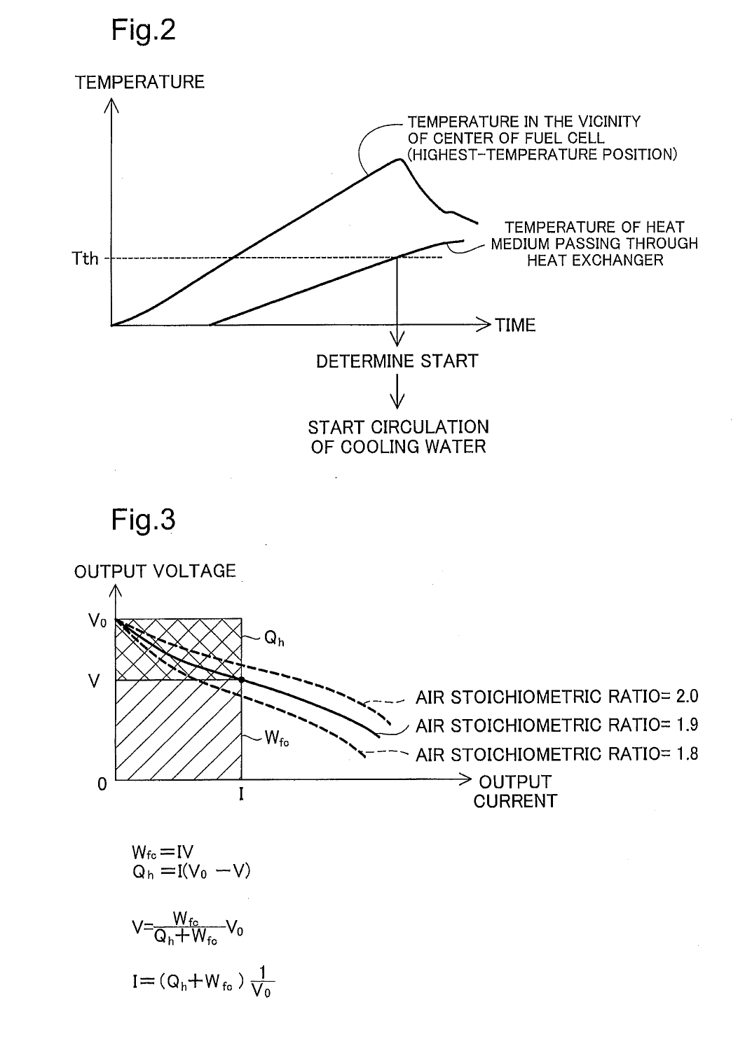

FIG. 2 illustrates the circulation start timing of cooling water at the start-up of the fuel cell 100. FIG. 2 shows the time on the abscissa and the temperature of the fuel cell 100 and the temperature of the heat medium on the ordinate.

The circulation controller 210 determines whether the temperature of the heat medium measured by the temperature sensor 178 exceeds a predetermined level Tth, and when it is determined that the temperature of the heat medium exceeds the predetermined level Tth, starts the water pump 71 to start circulation of cooling water. As shown in FIG. 2, the temperature of the fuel cell 100 starts decreasing at the start of circulation of cooling water. The determination of starting circulation of cooling water based on the temperature of the heat medium is due to the reason described below.

During warm-up operation at the start-up of the fuel cell 100, non-circulation of cooling water is preferable, in order to enable the temperature of the fuel cell 100 to reach the favorable operating temperature (for example, about 70° C.) promptly, i.e., in order to reduce the time required for the warm-up operation. In the configuration that determines the start of circulation of cooling water based on the temperature of cooling water, however, non-circulation of cooling water makes it difficult to estimate the temperature of the fuel cell 100 from the temperature of cooling water. This may lead to the difficulty in accurately determining the circulation start timing of cooling water and may thus cause overheat of the fuel cell 100. The configuration of this embodiment, on the other hand, determines the start of circulation of cooling water based on the temperature of the heat medium, thus enabling circulation of cooling water to start at the adequate timing on the basis of the temperature of the fuel cell 100 and thereby preventing overheat of the fuel cell 100.

The amount of heat of the fuel cell 100 taken by the heat medium in the heat exchanger 170 is relatively smaller than the amount of heat taken by circulation of cooling water, so that the start-up process may omit the operation of heating the end plates 110 and the end cells at the ends of the cell stack 140 at the start-up of the fuel cell 100. The temperature of the fuel cell 100 promptly approaches to the favorable operating temperature. This effectively prevents a decrease in cell voltage even at the cold start, e.g., in the cold region, thus ensuring a greater amount of output current. This results in increasing the amount of heat generated by the fuel cell 100 and thereby improves the start-up property of the fuel cell 100 in the cool environment.

The improved start-up property of the fuel cell 100 in the cool environment reduces the requirement for scavenging operation during stop of the fuel cell 100. The scavenging operation scavenges and dries the inside of the fuel cell 100, in order to prevent the water content from being frozen in the fuel cell 100 during the stop.

The heat generated in the fuel cell 100 during the warm-up operation is taken by the heat exchanger 170. The time required for the warm-up operation of the fuel cell 100 depends on whether the temperature of the end cell located at the end of the cell stack 140 increases to a predetermined level. The heat removal by the heat exchanger 170 accordingly does not have the effect of extending the time required for the warm-up operation.

FIG. 3 illustrates the relationship between the output characteristics of the fuel cell 100 and the air stoichiometric ratio. The oxidizing gas regulator 220 regulates the supply amount of the oxidizing gas supplied to the fuel cell 100, so as to adjust the air stoichiometric ratio.

The “air stoichiometric ratio” herein means the ratio of the amount of the oxidizing gas (air) to be used for power generation in the fuel cell 100 to the amount of the oxidizing gas (air) supplied to the fuel cell 100. When oxygen gas included in the oxidizing gas supplied to the fuel cell 100 is all used for power generation, the air stoichiometric ratio is equal to 1.0. During the operation of the fuel cell system 10, the air stoichiometric ratio is generally set to a larger value than 1.0 (e.g., 1.8). As clearly understood from the graph of FIG. 3, the relationship between the output voltage V and the output current I of the fuel cell 100 is affected by the air stoichiometric ratio.

The oxidizing gas regulator 220 sets the supply amount of the oxidizing gas supplied to the fuel cell 100, based on an output W_{fc} required for the fuel cell 100 and an amount of heat Qh required by the air conditioning device 150. More specifically, the oxidizing gas regulator 220 may calculate the output voltage V (Equation (3)) and the output current I (Equation (4)) from Equations (1) and (2) given below. The oxidizing gas regulator 220 may subsequently set the air stoichiometric ratio satisfying the calculated output voltage V and output current I, so as to set the supply amount of the oxidizing gas.

W_{fc}=I×V (1)

Qₕ=I×(V₀−V) (2)

V=W_{fc}×V₀/(Qₕ+W_{fc}) (3)

I=(Qₕ+W_{fc})/V₀ (4)

where V₀ represents the output voltage of the fuel cell 100 when the current I is equal to 0.

According to this embodiment, the relationship between the output voltage V and the output current I with respect to each air stoichiometric ratio is stored in advance in a memory. The oxidizing gas regulator 220 refers to the relationship between the output voltage V and the output current I with respect to each air stoichiometric ratio stored in the memory to select the air stoichiometric ratio satisfying the output voltage V and the output current I and set the supply amount of the oxidizing gas.

After setting the supply amount of the oxidizing gas, the oxidizing gas regulator 220 controls the air pump 60 to enable the oxidizing gas of the set supply amount to be supplied to the fuel cell 100. This allows the control satisfying the output required for the fuel cell 100 and the amount of heat required by the air conditioning device 150.

As described above, the fuel cell system 10 of the embodiment efficiently uses the heat generated in the fuel cell 100 and allows efficient heating by using the heat generated in the fuel cell 100.

### B. Second Embodiment

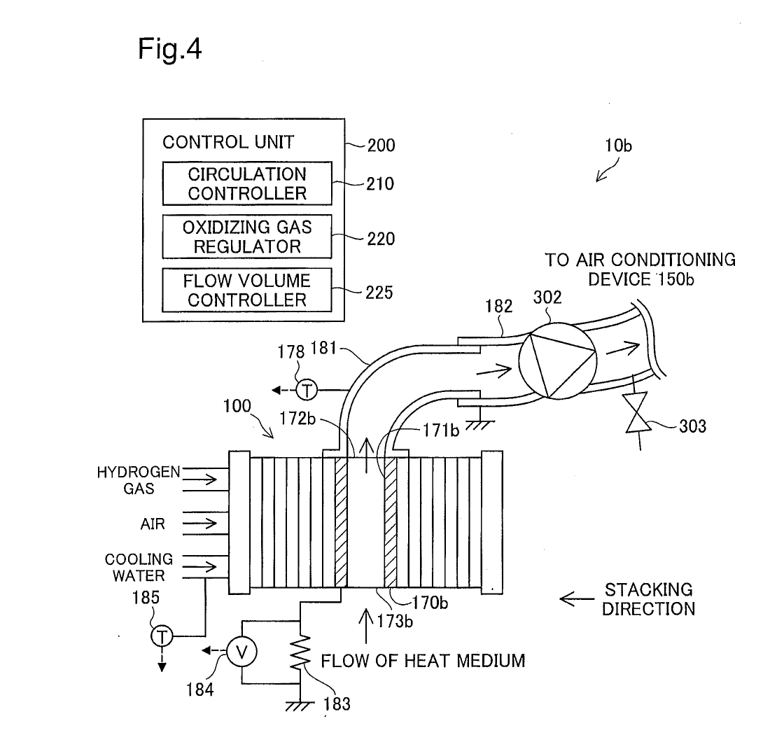

FIG. 4 illustrates the main part of the configuration of a fuel cell system 10b according to a second embodiment. The configuration of the second embodiment differs from the configuration of the first embodiment shown in FIG. 1 mainly by the following points but is otherwise similar to the configuration of the first embodiment:
The heat medium flowing through a flow channel 171b in a heat exchanger 170b is a gas (outside air);
An air conditioning device 150b discharges the heat medium (gas) passing through the flow channel 171b in the heat exchanger 170b out of the vent of the vehicle interior 12 for heating;
The control unit 200 additionally includes a flow volume controller 225 that controls the flow volume of the heat medium by regulating a blower 302; and
A temperature sensor 185 is additionally provided in the piping that allows passage of cooling water, to measure the temperature of cooling water.

As described above, according to this embodiment, the air conditioning device 150 uses the gas (outside air) as the heat medium and discharges the heat medium out of the vent. This configuration enables omission of a heat exchanger from the air conditioning device 150b.

The potential in the periphery of the heat exchanger 170b is described. An insulating duct 181 is connected with a flow outlet 172b of the heat exchanger 170b, and a piping 182 is further connected with the duct 181. The piping 182 is connected with the vehicle body and is grounded. This configuration prevents the potential of the fuel cell 100 from being transmitted to the outside.

A flow inlet 173b of the heat exchanger 170b is connected with the vehicle body across a resistor 183 and is grounded. A voltage detector 184 that detects a potential difference between both ends of the resistor 183 is connected in series with the resistor 183. The fuel cell 100 is in the potentially floating state, so that dielectric breakdown occurring in the fuel cell 100 causes a potential difference between both the ends of the resistor 183. The dielectric breakdown of the fuel cell 100 may thus be detected by detecting the potential difference between both the ends of the resistor 183.

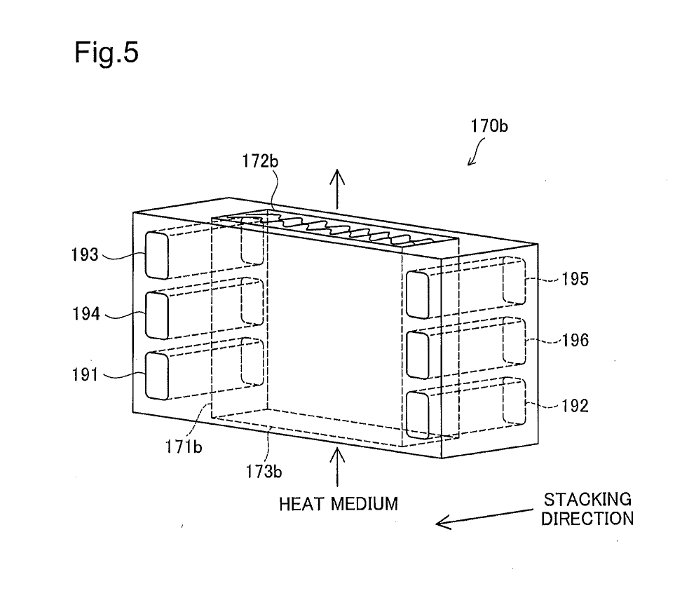

FIG. 5 illustrates the configuration of the heat exchanger 170b according to the second embodiment. The flow channel 171b is formed at the approximate center inside the heat exchanger 170b to allow passage of the gas as the heat medium. This flow channel 171b is arranged in the direction perpendicular to the stacking direction of the fuel cell 100.

Through holes 191 and 192 formed to allow passage of cooling water and through holes 193, 194, 195 and 196 formed to allow passage of the reactive gases are arranged on the respective sides of the flow channel 171b. Forming the through holes 191 and 192 to allow passage of cooling water in the heat exchanger 170b as described in this embodiment allows the heat of cooling water to be transferred to the heat exchanger 170b, thus enabling efficient warm-up of the heat exchanger 170b. This configuration also does not need to provide a separate flow channel to allow passage of cooling water, thus saving the space. The through holes 191 and 192 provided to allow passage of cooling water have small contact area with cooling water and may thus not require special cleaning to prevent degradation of cooling water.

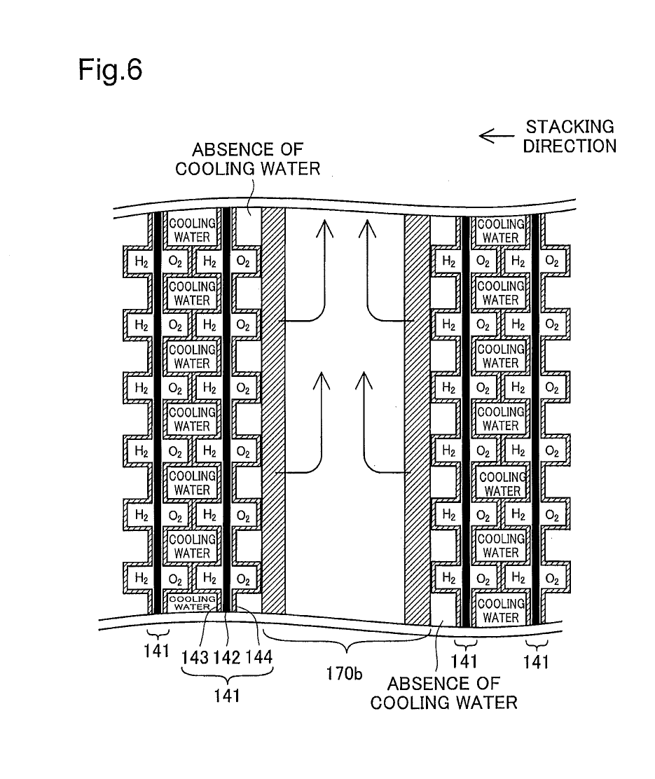

FIG. 6 illustrates an enlarged cross section of the heat exchanger 170b and its periphery. Each of the cells 141 constituting the cell stack 140 includes an MEA (membrane electrode assembly) 142 and separators 143 and 144 that are placed to hold the MEA 142 therebetween. The separator 143 has a flow channel provided to allow passage of hydrogen gas as the fuel gas, while the separator 144 has a flow channel provided to allow passage of the air as the oxidizing gas. A flow channel provided to allow passage of cooling water is formed between the respective adjacent cells 141.

According to this embodiment, cooling water is not supplied to the flow channels for cooling water that are in contact with the heat exchanger 170b. This is due to the following reason. The heat of the cells 141 located on the respective sides of the heat exchanger 170b are transferred to the heat exchanger 170b, so that the cells 141 located on the respective sides of the heat exchanger 170b can be cooled down without the flow of cooling water. Similarly the supply of cooling water to the flow channels that are in contact with the heat exchanger 170 may be omitted in the configuration of the first embodiment.

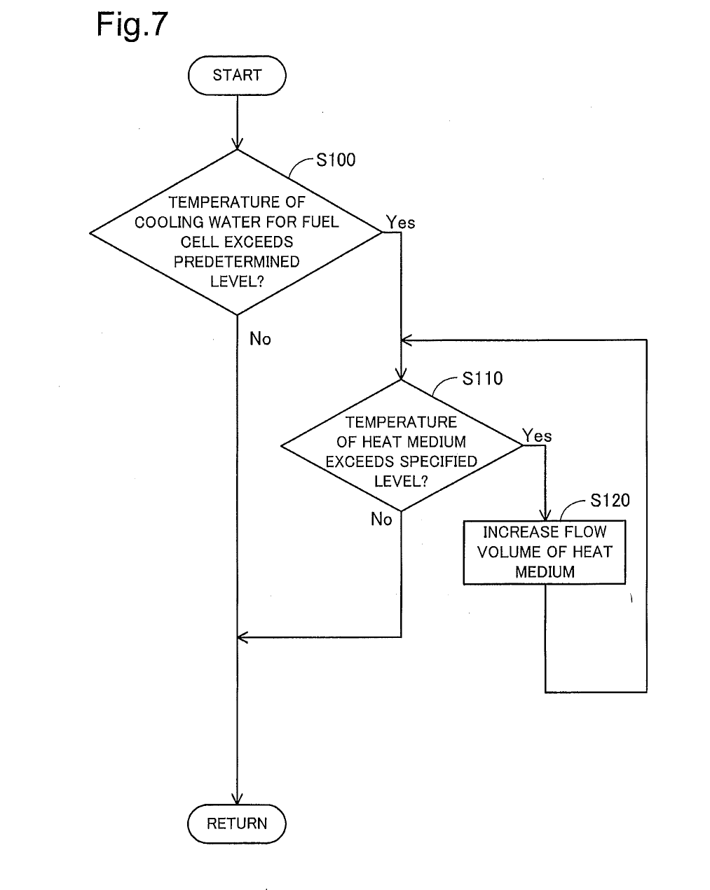

FIG. 7 is a flowchart showing the procedure of controlling the flow volume of the heat medium. The flow volume controller 225 repeatedly performs the processing flow of FIG. 7 at predetermined time intervals, so as to prevent a temperature increase of the fuel cell 100.

At step S100, the flow volume controller 225 determines whether the temperature of cooling water measured by the temperature sensor 185 exceeds a predetermined level. When it is determined that the measured temperature of cooling water exceeds the predetermined level (step S100: Yes), the flow volume controller 225 subsequently determines whether the temperature of the heat medium measured by the temperature sensor 178 exceeds a specified level (step S110). When it is determined that the measured temperature of the heat medium exceeds the specified level (step S110: Yes), the flow volume controller 225 controls the blower 302 to increase the flow volume of the heat medium passing through the heat exchanger 170b (step S120) and returns to the determination at step S110.

When it is determined that the temperature of cooling water does not exceed the predetermined level at step S100 or when it is determined that the temperature of the heat medium does not exceed the specified level at step S110, on the other hand, the flow volume controller 225 terminates the processing flow.

Controlling the flow volume of the heat medium based on the temperature of cooling water and the temperature of the heat medium as described above effectively prevents a temperature increase of the fuel cell 100, thus preventing a temperature increase of the electrolyte membrane included in the MEA 142 and protecting the electrolyte membrane from being dried.

When there is no heating requirement from the air conditioning device 150b, a valve 303 is opened. This stops the supply of the heat medium to the air conditioning device 150b even in the operating state of the blower 302. This stops the delivery of the heat medium from the air conditioning device 150b, while maintaining the flow of the heat medium in the heat exchanger 170b.

As described above, the fuel cell system 10b of this embodiment has the similar effects to those of the above embodiment and additionally allows efficient heating by utilizing the gas (outside air) as the heat medium.

### C. Third Embodiment

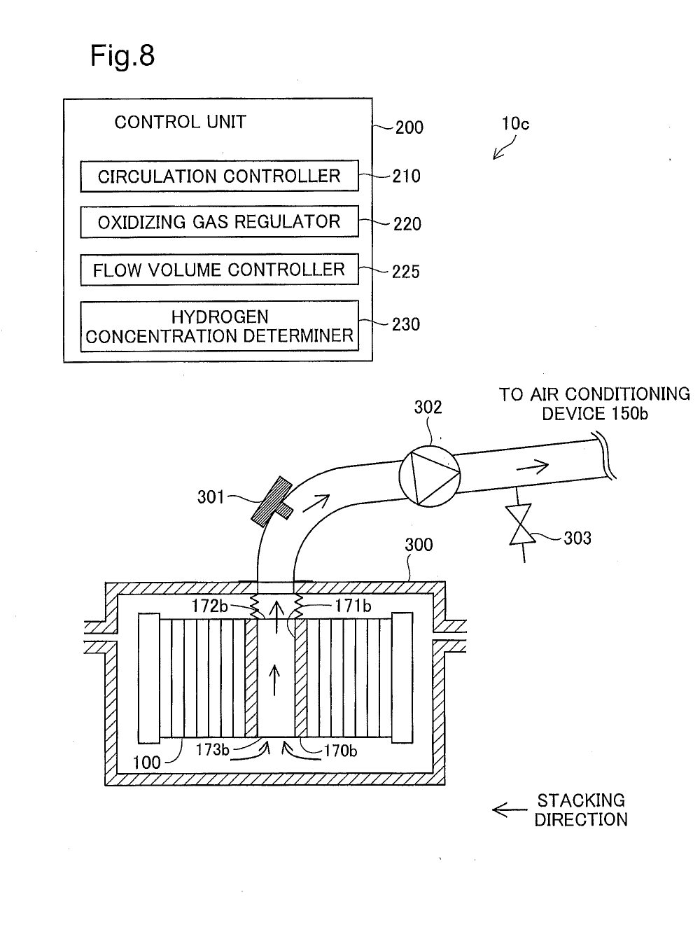

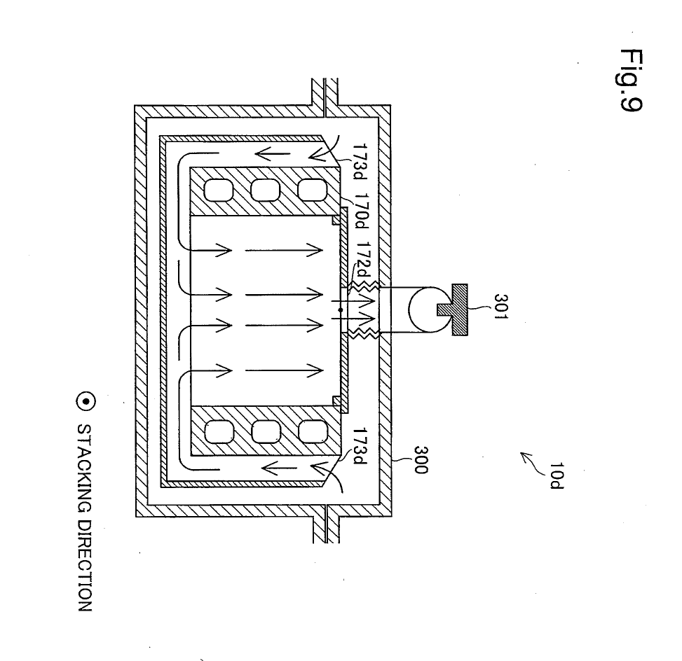

FIG. 8 illustrates the main part of the configuration of a fuel cell system 10c according to a third embodiment. The configuration of the third embodiment differs from the configuration of the second embodiment shown in FIG. 4 mainly by the following points but is otherwise similar to the configuration of the second embodiment:
A casing 300 is additionally provided to cover over the fuel cell 100;
The flow inlet 173b of the flow channel 171b of the heat exchanger 170b is located in the inner space of the casing 300; and
A hydrogen detector 301 is provided on the piping that connects the heat exchanger 170b with the air conditioning device 150b.

According to this embodiment, the casing 300 is additionally provided to cover over the fuel cell 100. Locating the flow inlet 173b of the flow channel 171b of the heat exchanger 170b in the inner space of the casing 300 effectively prevents any foreign substance, such as water droplet or dust, from flowing in through the flow inlet 173b of the heat exchanger 170b. This arrangement also allows omission of waterproof treatment of the heat exchanger 170b.

Additionally, it is preferable that the hydrogen detector 301 is provided on the piping that connects the heat exchanger 170b with the air conditioning device 150b as described in this embodiment. This is due to the following reason.

When hydrogen gas as the fuel gas is leaked from the fuel cell 100, the inside of the casing 300 is filled with the leaked hydrogen gas. The hydrogen gas filled in the casing 300 passes through the flow channel 171b of the heat exchanger 170b and through the piping that connects the heat exchanger 170b with the air conditioning device 150b and is supplied to the air conditioning device 150b. The, hydrogen detector 301 provided on the piping that connects the heat exchanger 170b with the air conditioning device 150b can thus detect a leakage of the fuel gas (hydrogen gas) from the fuel cell 100.

The control unit 200 of this embodiment additionally has a hydrogen concentration determiner 230. The hydrogen concentration determiner 230 determines whether the hydrogen concentration detected by the hydrogen detector 301 exceeds a predetermined value and, when the detected hydrogen concentration exceeds the predetermined value, stops the blower 302 to stop the supply of the heat medium to the air conditioning device 150b. This configuration interferes with the supply of the hydrogen gas to the air conditioning device 150b and thereby prevents the delivery of the hydrogen gas into the vehicle interior 12.

As described above, the fuel cell system 10c of this embodiment has the similar effects to those of the above embodiments and additionally enables detection of leakage of the hydrogen gas from the fuel cell 100.

### D. Fourth Embodiment

FIG. 9 illustrates the main part of the configuration of a fuel cell system 10d according to a fourth embodiment. FIG. 9 shows a cross section of a heat exchanger 170d and a casing 300 taken on the plane perpendicular to the stacking direction of the fuel cell 100. The configuration of the fourth embodiment differs from the configuration of the third embodiment shown in FIG. 8 by only the location of a flow inlet 173d of the heat medium provided in the upper portion of the inner space of the casing 300, but is otherwise similar to the configuration of the third embodiment.

Since the hydrogen gas as the fuel gas is light in weight than the air, the hydrogen gas leaked from the fuel cell 100 is accumulated in the upper portion of the inner space of the casing 300. Providing the flow inlet 173d of the heat exchanger 170d in the upper portion of the inner space of the casing 300 enables the hydrogen gas accumulated in the upper portion of the inner space of the casing 300 to be fed to the hydrogen detector 301. This arrangement enables a leakage of the hydrogen gas to be detected with a high sensitivity before the inside of the casing 300 is filled with the hydrogen gas.

The flow inlet 173d may be formed as part of the heat exchanger 170b or may alternatively be provided as a separate member from the heat exchanger. For example, a flow inlet of a duct provided in the periphery of the heat exchanger may be used as the flow inlet 173d.

As described above, the fuel cell system 10d of this embodiment has the similar effects to those of the above embodiments and additionally enables detection of leakage of the hydrogen gas from the fuel cell 100 with a high sensitivity.

### E. Modifications

The invention is not limited to the above embodiments but various modifications and variations may be made to the embodiments without departing from the scope of the invention. Some examples of possible modifications are given below.

Modification 1:

According to the above first embodiment, the circulation controller 210 controls the start of circulation of cooling water at the start-up of the fuel cell 100, based on the temperature of the heat medium measured by the temperature sensor 178. The circulation controller 210 may additionally control the three-way valve 75 to change the flow channel of cooling water and control the flow rate of cooling water, based on the temperature of the heat medium. The circulation controller 210 may also control the circulation of cooling water, based on the temperature of cooling water.

Modification 2:

According to the above second embodiment, the flow volume controller 225 increases the flow volume of the heat medium, based on the temperature of cooling water and the temperature of the heat medium. The control may additionally decrease the flow volume of the heat medium, based on the temperature of cooling water and the temperature of the heat medium. This modification enables adequate regulation of the temperature of the fuel cell 100.

Modification 3:

According to the above third embodiment, the hydrogen detector 301 is provided on the piping that connects the heat exchanger 170b with the air conditioning device 150b. The hydrogen detector 301 may be provided at any other suitable location that enables detection of the hydrogen concentration of the heat medium. For example, the hydrogen detector 301 may be provided inside the flow channel 171b of the heat exchanger 170b.

Modification 4:

The above respective embodiments describe the fuel cell system mounted on the vehicle. The invention is, however, also applicable to a stationary fuel cell system for domestic use or for business use. The fuel cell system of the invention may also be mounted on another moving body, such as aircraft.

Modification 5:

Part of the functions implemented by the software configuration in each of the above embodiments may be implemented by the hardware configuration, while part of the functions implemented by the hardware configuration in each of the above embodiments may be implemented by the software configuration.

Modification 6:

Any of the configurations described in the respective embodiments may be adequately applied or may be adequately omitted in the respective embodiments.

### REFERENCE SIGNS LIST

10 Fuel cell system
10b Fuel cell system
10c Fuel cell system
10d Fuel cell system
12 Vehicle interior
50 Hydrogen tank
51 Shut valve
52 Regulator
53 Piping
54 Exhaust piping
60 Air pump
61 Piping
63 Exhaust piping
70 Radiator
71 Water pump
72 Piping
73 Piping
74 Piping
75 Three-way valve
100 Fuel cell
110 End plate
140 Cell stack
141 Cell
142 Manifold
143 Separator
144 Separator
150 Air conditioning device
150b Air conditioning device
152 Heat exchanger
170 Heat exchanger
170b Heat exchanger
170d Heat exchanger
171 Flow channel
171b Flow channel
172 Flow outlet
172b Flow outlet
173 Flow inlet
173b Flow inlet
173d Flow inlet
174 Flow channel
175 Flow channel
178 Temperature sensor
179 Circulation pump
181 Duct
182 Piping
183 Resistor
184 Voltage detector
185 Temperature sensor
191 Through hole
193 Through hole
200 Control unit
210 Circulation controller
220 Oxidizing gas regulator
225 Flow volume controller
230 Hydrogen concentration determiner
300 Casing
301 Hydrogen detector
302 Blower
303 Valve

1. (canceled)

2. (canceled)

3. A fuel cell system, comprising:
a fuel cell configured to have a cell stack obtained by stacking a plurality of cells;
a heat exchanger located in a middle position in a stacking direction of the cell stack to be placed between adjacent cells of the cell stack and configured to have a flow channel that allows passage of a fluid for heat exchange;
a heating system configured to use the fluid that passes through the flow channel for heating;
a temperature sensor provided to detect temperature of the fluid;
a circulation circuit arranged to circulate a coolant for cooling down the fuel cell; and
a circulation controller configured to control flow of the coolant that is circulated through the circulation circuit, based on the detected temperature of the fluid.

4. The fuel cell system according to claim 3, wherein
the circulation controller starts circulation of the coolant, when it is determined that the detected temperature of the fluid exceeds a predetermined level.

5. A fuel cell system, comprising:
a fuel cell configured to have a cell stack obtained by stacking a plurality of cells;
a heat exchanger located in a middle position in a stacking direction of the cell stack to be placed between adjacent cells of the cell stack and configured to have a flow channel that allows passage of a fluid for heat exchange;
a heating system configured to use the fluid that passes through the flow channel for heating; and
a casing provided to cover over the fuel cell, wherein
the fluid is a gas, and
a flow inlet that allows the fluid to flow into the flow channel of the heat exchanger is provided in an inner space of the casing.

6. The fuel cell system according to claim 5, further comprising:
a hydrogen concentration detector configured to detect hydrogen concentration of the fluid.

7. The fuel cell system according to claim 6, further comprising:
a fluid supplier configured to supply the fluid that passes through the flow channel of the heat exchanger to the heating system; and
a hydrogen concentration determiner configured to determine whether the detected hydrogen concentration exceeds a predetermined value, wherein
the fluid supplier stops the supply of the fluid to the heating system when the detected hydrogen concentration exceeds the predetermined value.

8. The fuel cell system according to claim 6, wherein
the flow inlet is provided in an upper portion of the inner space of the casing.

9. A fuel cell system, comprising:
a fuel cell configured to have a cell stack obtained by stacking a plurality of cells;
a heat exchanger located in a middle position in a stacking direction of the cell stack to be placed between adjacent cells of the cell stack and configured to have a flow channel that allows passage of a fluid for heat exchange;
a heating system configured to use the fluid that passes through the flow channel for heating;
a temperature sensor provided to detect temperature of the fluid;
a second temperature sensor configured to detect temperature of a coolant for cooling down the fuel cell; and
a flow rate controller configured to control a flow rate of the fluid, based on the detected temperature of the coolant and the detected temperature of the fluid.

10. The fuel cell system according to claim 9, wherein
the flow rate controller increases the flow rate of the fluid, when it is determined that the detected temperature of the coolant exceeds a specified level and when it is determined that the detected temperature of the fluid exceeds a predetermined level.

11. The fuel cell system according to claim 9, further comprising:
a fluid supplier configured to supply the fluid that passes through the flow channel of the heat exchanger to the heating system; and
a valve provided in the fluid supplier and configured to release the fluid that passes through the flow channel of the heat exchanger, to outside, wherein
the fluid is a gas, and
the valve is opened when the heating system does not use the fluid for heating.

12. The fuel cell system according to claim 3, wherein
the heat exchanger is provided with a through hole formed to allow passage of a coolant for cooling down the fuel cell.

13. The fuel cell system according to claim 3, wherein
the heat exchanger is provided at an approximate center in the stacking direction of the cell stack.

14. The fuel cell system according to claim 3, further comprising:
an oxidizing gas supply volume setter configured to set a supply volume of an oxidizing gas supplied to the fuel cell, based on an output required for the fuel cell and an amount of heat required by the heating system; and
an oxidizing gas supplier configured to supply the oxidizing gas to the fuel cell, based on the set supply volume of the oxidizing gas.

15. A fuel cell system, comprising:
a fuel cell configured to have a cell stack obtained by stacking a plurality of cells;
a heat exchanger located in a middle position in a stacking direction of the cell stack to be placed between adjacent cells of the cell stack and configured to have a flow channel that allows passage of a fluid for heat exchange;
a heating system configured to use the fluid that passes through the flow channel for heating; and
a voltage detector, wherein
the fuel cell is in a potentially floating state, and
the heat exchanger is grounded via a resistor,
the voltage detector is configured to detect a potential difference between both ends of the resistor.

16. A heating method by using heat of a fuel cell, comprising the steps of:
providing a fuel cell configured to have a cell stack obtained by stacking a plurality of cells;
providing a heat exchanger located in a middle position in a stacking direction of the cell stack to be placed between adjacent cells of the cell stack and configured to have a flow channel that allows passage of a fluid for heat exchange;
using the fluid that passes through the flow channel for heating;
detecting temperature of the fluid;
circulating a coolant for cooling down the fuel cell; and
controlling flow of the coolant, based on the detected temperature of the fluid.
